(19) United States
(12) Patent Application Publication
(10) Pub. No.: US 2006/0039540 A1
(43) Pub. Date: Feb. 23, 2006

(54) Denial of 911 emergency service attacks prevention method

(76) Inventor: Anton Issinski, Burnaby (CA)

Correspondence Address: Anton Issinski, 1405 THE MADISON 4689 HAZEL ST, BURNABY, BC, V5H 4R6, CA

(21) Appl. No.: 10/922,407

(22) Filed: Aug. 20, 2004

(51) Int. Cl. H04M 11/04; H04L 12/66

(52) U.S. Cl. 379/45; 379/49

(57) ABSTRACT

A method for preventing Distributed Denial Of Service (DDOS) attacks on telecommunication systems handling special number calls such as 911 emergency systems launched from compromised personal computers equipped with modems connected to public telephone networks is disclosed. For each initiated call, a probability that the originator of the call is a computer device rather then a human is determined. The call is then further handled using determined probability of the call originator.

### BACKGROUND OF THE INVENTION

Wide spreading and popularity of personal computers lead to a phenomenon known as computer viruses. Virus is a software program written by individuals with intention to enter a computer system without the users permission. Viruses spread by replicating themselves into other computers mainly using communication networks and vulnerabilities of modern operating systems. During the epidemic period millions of computers may become infected within few days. According to some software security sources [1], there are about 70,000 computer viruses known at the present time and about 2,000 new ones emerging every year.

Once virus is executed it gains virtually unlimited control over the computer resources, including peripheral equipment connected to the system. At this point virus writers decide what to do next with the compromised computer system. They may leave a ‘backdoor’ open—a software tool for remote controlling the infected computer or replace the virus with a ‘zombie’—a non-spreading undetectable program that runs on the background and periodically checks public servers controlled by the attacker for downloading new executable instructions.

One of the known damages that computer viruses do is performing distributed denial of service (DDOS) attacks on popular corporate Internet web servers. The mechanism of the attack is based on the large but still limited performance capacity of the server computer and local network equipment. During the attack, thousands and could be millions of compromised computers start sending request to the target clogging networks and backlogging the server. As the result, legitimate requests sent from regular users cannot reach the destination server causing the denial of service effect.

Much more dangerous but fortunately not spread yet form of DDOS attack is one that is targeting public telephone networks launched from personal computers equipped with modems. Such attacks may easily disrupt public telephone communications for prolonged periods of time. An example of the most vulnerable target would be public service answering points with the well-known numbers such as 911 emergency services.

The key technology of this form of attack is a modem. Modem is a hardware equipment for connecting computers over telephone lines and for sending/receiving facsimile messages. Almost every modem personal computer has a pre-installed modem. Unlike other computer hardware modems have a standard and very simple application programming interface to control it. Using this interface, computer programs can dial telephone numbers as they would be regular telephone sets. The programming interface is so easy to use that the 911 call can be placed from the most of the systems by typing and executing less then 20 characters long text file.

Of course not every computer with a modem installed is connected to the public telephone network. Most corporations in urban areas will use high-speed digital networks to connect to the Internet and even have a security policy restricting office computers from direct dial-up access to the outside networks.

But at the same time increasing of security in corporate LANs lead to increasing of modem use. It is a common practice for an average corporation to have a private dial-up access to the LAN that requires at least one modem permanently running and connected to the public telephone network. Companies with branches located in different geographical areas use modems for remote administration of firewalls by administrators at central locations.

Yet another common application of a modem is to send and receive facsimile messages. This also requires a permanent connection to the public telephone network and a computer with a modern operating system installed to support facsimile functions.

And still a large percentage of home users and business trawlers use modems for their main purposes—for dial-up network access.

As the result, the modern community has a tremendous accumulation of both the hardware and the technology for supplying the DDOS attacks on public telephone networks and without proper contra-measures at the present time it is left up to the attackers mercy to decide how much damage bring to the public.

### SUMMARY OF THE INVENTION

It is the goal of the present invention to increase the security of the public telephone networks and to reduce their vulnerability to the DDOS attacks launched from computer systems equipped with the modem devices.

In accordance with one aspect of the present invention, a method is provided to reduce the load onto the telecommunication network, public safety answering point (PSAP) staff and action stations during the periods of DDOS attacks. For each initiated call, the probability that the originator of the call is a computer device rather then a human is determined. The call is then further handled using determined probability of the call originator. For example, during high volume situations caused by DDOS attacks, calls may be re-routed, prioritized or terminated based on the obtained probability to avoid overflow.

In another aspect of the present invention, computers operating system, software and peripheral equipment possibly capable of being used in the launching DDOS attacks are patched to prevent automatic dial-up to well-known service numbers such as 911 emergency number. For example, the operating system modem and serial port drivers or anti-virus applications may be modified to analyze the dial-up instructions and issue a confirmation prompt if the number requested to dial is a well-known PSAP number.

### BRIEF DESCRIPTION OF THE DRAWINGS

FIG. 1 is a prior art schematic diagram illustrating a possible overflow situation at PSAP during DDOS attack.

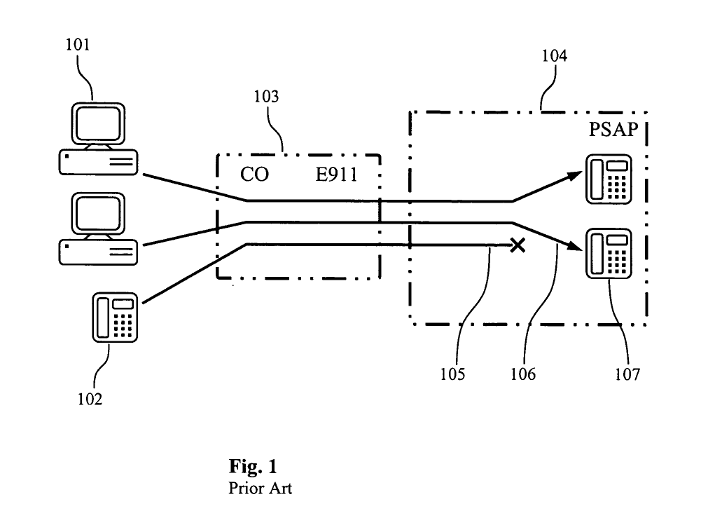

FIG. 2 is a schematic diagram illustrating the preferred embodiment of the first method of the present invention.

### DETAILED DESCRIPTION OF THE INVENTION

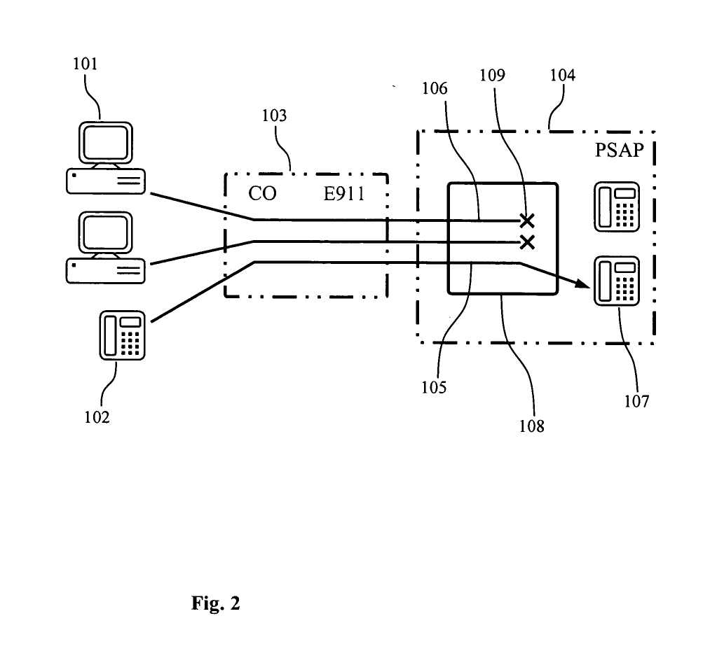

FIG. 2 is a schematic diagram illustrating the preferred embodiment of the first method of the present invention. In FIG. 2, compromised computer systems equipped with modems 101 launching DDOS attack are initiating telephone calls 106 targeting PSAP 104. The call initiator detection module 108 installed at the PSAP 104 analyses the call request, determines that the call was placed by a computer device and terminates it 109 before forwarding it to the operator 107. The legitimate calls 105 initiated by humans 102 reach operator 107.

To determine whether the call was originated by a modem or a human, one can analyze the DTMF tones pattern issued during the call placement by the subscriber. For example, when a modem dials up a number using the DTMF tone dialing mode, it provides quite accurate and constant duration of the DTMF tone followed by the fixed silent period. In contrast, when a human dials a number, the duration of the tone or a silent phase will be random and vary from one tone to another.

Another method of determining that the human originates the call is to give automatic pre-recorded instructions to the caller to push certain buttons on the touch-tone telephone and to compare the DTMF tones response with the expected sequence. This method can be used during more severe PSAP overflow situations.

Also, acoustic background noise will be specific only to the human-placed calls while modem-placed calls will provide virtually no background noise in the line.

Keeping a database of info about whether the network subscriber ever used modem connections in the past will also add to the overall rating of the call.

According to another aspect of the invention, computers operating system, software and peripheral equipment possibly capable of being used in the launching DDOS attacks are patched to prevent automatic dial-up to well-known service numbers such as 911 emergency numbers. For example, the operating system modem and serial port drivers or anti-virus applications may be modified to analyze the dial-up instructions and issue a confirmation prompt if the number requested to dial is a well-known PSAP number.

What is claimed is:

1. A method for preventing denial of service attacks on telecommunication systems handling special number calls, the system including: a telecommunication network, at least one special number answering point connected to the said network, means of placing telephone calls to said answering point by humans, means of placing calls to said answering point by computer devices, the method comprising steps of:
(a) determining a likelihood of whether the originator of a call to said answering point is a human or a device, and
(b) handling said call based on said call originator likelihood.

2. A method of claim 1 where the method for determining call originator likelihood includes steps of:
(a) measuring call placement request DTMF tone or pause duration, and
(b) comparing measured data to a pre-defined set of data.

3. A method of claim 1 where the method for determining call originator likelihood includes steps of detecting a human voice in the call request.

4. A method of claim 1 where the method for determining call originator likelihood includes steps of:
(a) instructions to the caller to enter one or more characters from the touch-phone,
(b) comparing the reply tones with the requested character sequence.

5. A method of claim 1 where the method for determining call originator likelihood includes steps of detecting acoustic or background noise caused by the call originator device microphone.

6. A method of claim 1 where the method for determining call originator likelihood includes steps of:
(a) collecting information about location of computer devices capable of placing automatic telephone calls to telecommunication networks,
(b) determining caller location during handling the incoming call
(c) comparing the said caller location with the said collected information.

7. A method for preventing attacks on telecommunication systems handling special number calls from a computer system capable of placing an outgoing telephone call to a telecommunication network connected to a special number answering point, the method comprising steps of:
(a) determining is an outgoing call request generated by the computer system likely to be a call to a special number answering point,
(b) handling the outgoing call request by said computer system based on said determined likelihood.
